(19) United States
(12) Patent Application Publication
(10) Pub. No.: US 2004/0104810 A1
(43) Pub. Date: Jun. 3, 2004

(54) Hand held illuminated safety signal

(76) Inventor: Burke H. Scott, Benton, IL (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/706,562

(22) Filed: Nov. 11, 2003

Related U.S. Application Data
(60) Provisional application No. 60/417,215, filed on Nov. 12, 2002.

(51) Int. Cl. G08B 5/22

(52) U.S. Cl. 340/321; 340/815.45; 40/586

(57) ABSTRACT

A hand held illuminated safety signal visible from opposite directions of traffic having a handle portion, a signal portion, an electrical source, illumination means, and an on/off switch. The illumination means is disposed within the signal portion. The illumination means having a multiplicity of LEDs arranged on a substantial planar surface.

### CROSS REFERENCES TO RELATED APPLICATIONS: None.

Statement as to rights to inventions made under Federally sponsored research and development: U.S. Provisional Application for Patent 60/417,215, filed Nov. 12, 2002, with title, “Hand Held Illuminated Safety Signal” which is hereby incorporated by reference. Applicant claims priority pursuant to 35 U.S.C. Par. 119(e)(i).

### BACKGROUND OF THE INVENTION

1. Field of the Invention

The present invention relates generally to a hand held sign and more particularly, a lightweight, easily constructed illuminated safety signal as used by school guards and road construction personnel.

2. Brief Description of Prior Art.

It is common practice to employ “crossing guards” in school zones, and “flag men” in construction areas for example, to control the traffic flow. Specifically, these individuals typically manipulate passive hand held signs which bear short, lettered, instruction messages to motorists such as “STOP” or “SLOW”. These messages are usually provided on planar surfaces of a sign board, and the sign board is typically mounted on a pole, the opposite end of the pole either being positioned on the ground or hand held.

For many reasons, including in climate weather, or the fact that school zones are typically in neighborhoods surrounded by homes, trees or shrubs that may reduce visibility by motorist to see the crossing guard, or construction zones which are often characterized by a dusty environment which again reduces visibility, there has been a longing standing desire to increase the noticeability of the hand held sign of the type briefly described above.

Various lighted sign structures have been suggested and many have been patented.

These tend to be heavier and certainly bulkier than the aforementioned hand held signs. Further, many of the prior art signs are heavier than desired and do not make use of reflective material as may be desired.

U.S. Pat. No. 6,204,777 to Lyons discloses a portable warning sign that is rotatably supported by the ground. '777 bears a printed message, and each of the letters comprising the word(s) of the message are outlined by a linear array of light emitting diodes. The light emitting diodes outlining the letters of the words tends to blend making the words difficult to read.

U.S. Pat. No. 6,134,820 to Martinez discloses a hand held signal including an edge which is the signal's case, and further includes a switch with a flasher switch. Inside the edge is a reflector and at the top of the edge is a light having a lens and a lens cover. Within the reflector is formed a designated message with reflective material tape which would normally be white. Although the illumination does obtain a certain level of attention, the level attention of the light is relatively minor. Further with the illumination disposed at the top of the edge, the light tends to blend with other lights in the driving environment.

U.S. Pat. No. 5,276,424 to Hegemann discloses a hand held sign having an imprinted message and further including around the periphery are flashing illuminated areas or windows, where only a single light is flashing at one time. Multiple flashing lights in sequence tend to consume a larger amount of energy and is more expensive to manufacture.

It is clear that an attention getting, lightweight, easily constructed hand held illuminated sign is needed and required in certain situations for safety purposes.

As will be seen from the subsequent description, the preferred embodiments of the present invention overcome shortcomings of the prior art.

### SUMMARY OF THE INVENTION

The present invention relates generally to an illuminated hand held safety signal as used by school guards and road construction personnel. The hand held sign generally includes a handle portion connected to a sign portion. The sign portion having a front surface, and a back surface. The front and back surfaces including aligned screw holes for receiving screws, said screws passing through the screw holes and interconnect the front surface to the back surface forming the sign portion. The front and back surfaces bears a printed portion displaying an informational message, i.e. an instruction word, on each side. The handle portion having a first end, a mid-section, and a second end opposite the first end.

Disposed within the sign portion is an illumination means, said illumination means to illuminate light through the front surface and back surfaces of the sign portion.

The hand held signal further including an electrical source, such as a rechargeable battery. The battery is preferably disposed within the handle portion, or can remain separate from the hand held signal. An on/off switch to activate the illumination means is preferably disposed at the approximate mid-section of the handle portion for convenient access. Activation of the on/off switch permits the operator to effectively illuminate the front and back surfaces of the sign portion.

Conventional wires extend from the battery and are connected to a connector disposed at the outermost end of the second end of the handle portion. Wires then extend from the connector up through the second end of the handle portion and is connected to the on/off switch. Wiring is appropriately connected between the on/off switch and the illumination means in the sign portion.

In an alternate embodiment, the handle portion having a first end and a second end opposite the first end. The first end configured to slide in and out of the larger diameter second end, and therefore, the first end and the second end will generally be telescopically engaged. The handle portion further including a threaded collar. Loosening said collar permits telescopically adjusting first end within the second end. Tightening the collar fixedly positions the first end within the second end at the selected adjustment.

### BRIEF DESCRIPTION OF THE DRAWINGS

FIG. 1 is an exploded front view of a preferred embodiment of the present invention, a hand held illuminated safety signal.

FIG. 2 is a front view of the illumination means of the hand held illuminated safety signal of FIG. 1.

FIG. 3 is a rear view of the illumination means of the hand held illuminated safety signal of FIG. 1.

FIG. 4 is a side view of the sign portion of the hand held illuminated safety signal of FIG. 1.

FIG. 5 is an exploded front view of an alternate embodiment of the present invention.

### DESCRIPTION OF THE PREFERRED EMBODIMENT

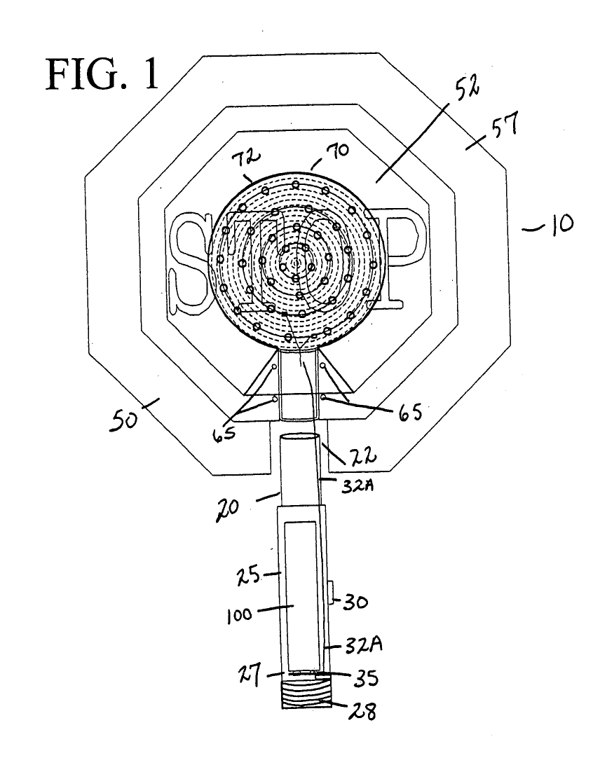

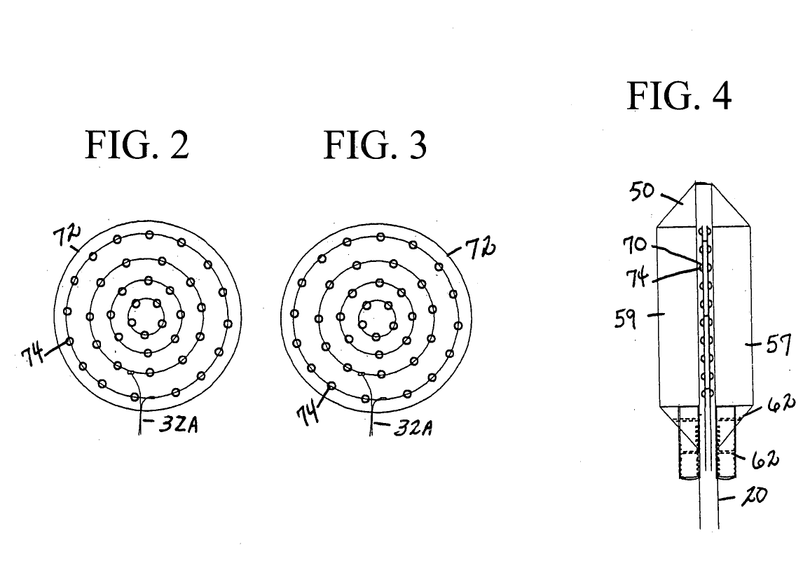

FIGS. 1-4 illustrate a preferred embodiment of a hand held illuminated safety signal 10 made in accordance with the present invention. The hand held signal 10 provides a lightweight, easily constructed illuminated safety signal as used for example, by school guards and road construction personnel.

Specifically, it will be noted in the drawings that the device relates to an attention getting hand held illuminated safety signal used in certain situations for safety purposes. In the broadest context, the device consists of components configured and correlated with respect to each other so as to attain the desired objective.

The hand held signal 10 generally includes an elongated handle portion 20 and a sign portion 50. As shown in the drawings, the sign portion 50 has a octagonal configuration which is a common configuration for a hand held signal. The sign portion 50 including a front surface 57 and a back surface 59 in communication with the front surface 57. The front surface 57 is identical construction to the back surface 59. As best shown in FIG. 4, the front and back surfaces 57, 59 being substantially flat surfaces and including aligned screw holes 62 for receiving screws 65. Said screws 65 passing through the screw holes 62 and interconnect the front surface 57 to the back surface 59 forming the sign portion 50. In the preferred embodiment, the front and back surfaces 57, 59 are made of a reflective material.

As shown in FIG. 1, the front surface 57, as well as the back surface 59 but not shown, bears a printed portion 52 displaying an informational message, i.e. an instruction word, on each side. In the embodiment shown, the word STOP is displayed in the printed portion 52 of the front surface 57. However, it is anticipated that frequently it will be desired to have other instruction words displayed such as the word SLOW or CAUTION.

Disposed within the sign portion 50 is an illumination means 70. In the preferred embodiment, the illumination means includes a substantially planar surface 72 having a multiplicity of LEDs 74 selectively arranged thereon. In this regard, the LEDs 74 are arranged so that the illumination means 70 illuminates in opposite directions. The illumination means 70 therefore illuminates light through the front surface 57, and further illuminates light through the back surface 59. Access to the illumination means 70 is permitted by removing the screws 65 from the surfaces 57, 59 and separating the surfaces 57, 59 making the enclosed components readily accessible.

The handle portion 20 is secured to the sign portion 50 at the lower edge of the sign portion 50 by a bolt or other suitable mechanism well known to those in the art. Said handle portion 20 having a first end 22 connected to the sign portion 50 as discussed above, a mid-section 25, and a second end 27 opposite the first end 22. Said mid-section 25 preferably having a cylindrical configuration for comfort when holding the handle portion 20 of the hand held signal 10. The second end 27 may further include a grip 28 for additional comfort when holding the handle portion 20. As will be understood, the handle portion 20 having the first end 22, the mid-section 25, and the second end 27, is hollow for housing various wiring and components of the invention as will be further discussed.

The hand held signal 10 further including an electrical source, such as a rechargeable battery 100. Electrical energy from the battery 100 is passed to the illumination means 70. An on/off switch 30 to activate the illumination means 70 is preferably disposed at the approximate mid-section 25 of the handle portion 20 for convenient access. Activation of the on/off switch 30 permits the operator to effectively illuminate the illumination means 70 so that both surfaces 57, 59 of the sign portion 50 illuminates light. Activation of the illumination means 70 may provide for the lights to remain constantly on, or flash as preferred. In the preferred embodiment, the battery 100 is disposed within the handle portion 20 as shown in FIG. 1. Alternatively, the battery 100 can be separate from the hand held signal 10. Maintaining the battery 100 separate from the hand held signal 10 provides a lighter-weight hand held device.

Conventional wires 32A extend from the battery 100 and as connected to a connector 35 disposed at the outermost end of the second end 27 of the handle portion 20. The wire 32A extends from the connector 35 up through the second end 27 of the handle portion 20 and is connected to the on/off switch 30 in the mid-section 25. The wiring 32A is further appropriately connected between the on/off switch 30 to the illumination means 70 in order to properly activate the illumination means 70 as discussed above.

The connector 35, the operational mechanics of which have not been shown, is designed to enable release of the wire 32A that extends from the battery 100 so that the battery 100 may be separated from the hand held signal 10 when the signal 10 is not being used or does not require illumination. This further enables separating the battery 100 from the signal 10 so that the battery 100 may be connected to a charger.

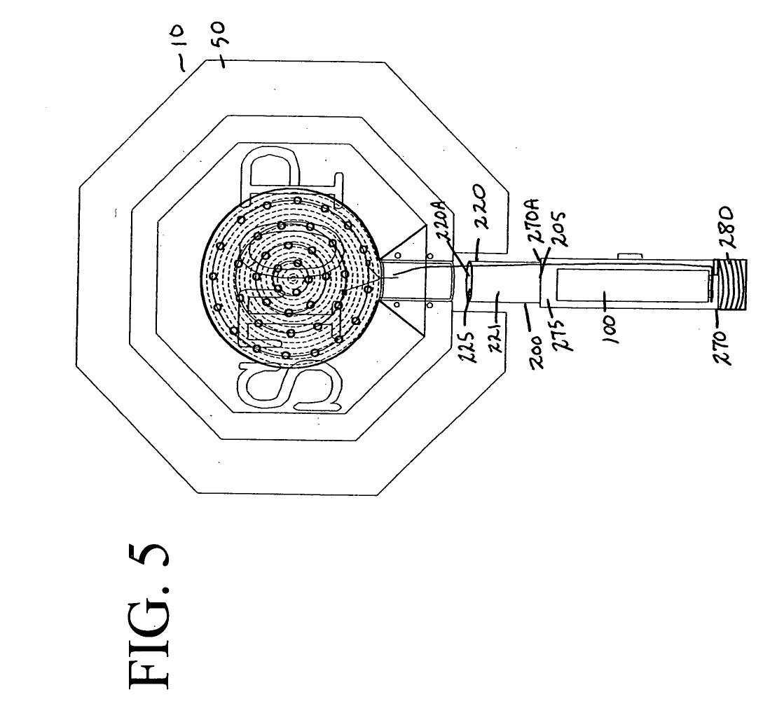

FIG. 5 illustrates a second embodiment of the present invention. The components of this alternate embodiment is identical to the hand held signal 10 described except that the hand portion 200 includes a first end 220 connected to the sign portion 50 and a second end 270. The first and second ends 220, 270 have bores 225 and 275 respectively, therethrough. The second end 270 having an opening 270A for access to the bore 275 of the second end 270. The first end 220 likewise including an opening 220A for access to the bore 225 of the first end 220. The first end 220 further including an extension portion 221, the extension portion 221 of the first end 220 is configured to slide in and out the bore 275 through the opening 270A of the larger diameter second end 270, and therefore, the first end 220 and the second end 270 will generally be telescopically engaged.

The handle portion 200 further including a threaded collar 205. Loosening said collar 205 permits telescopically adjusting the first end 220 within the second end 270.

Tightening the collar 205 fixedly positions the first end 220 within the second end 270 at the selected adjustment. Obviously this feature is useful when it is preferred that the sign portion 50 extend further upwardly during use. The second end 270 may further include a grip 280 for comfort when holding the handle portion 200.

Use of the signal 10 having the telescopically engaging handle portion 200 is identical to the preferred embodiment as previously described; except that the operator may loosen the collar 205 for adjusting the length of the handle portion 200 as described above. Depending upon the desired length dimensions of the handle portion 200, the first and second ends 220, 270 may be adjusted in length, specifically the extension portion 221 of the first end 220 is adjustably received within the bore 275 of the second end 270 to adapt to the desired length. The extension portion 221 of the first end 220 is telescopically adjusted as described above so that the length of the handle portion 200 is preferred. Tightening the collar 205 fixedly positions the first end 220 within the second end 270 at the selected adjustment.

Thus, it is apparent that there has been provided, in accordance with the present invention, a hand held illuminating safety signal that fully satisfies the objectives, aims and advantages set forth above. Although the description above contains many specificities, these should not be construed as limiting the scope of the invention but as merely providing illustrations of some of the presently preferred embodiments of this invention.

Thus the scope of the invention should be determined by the appended claims in the formal application and their legal equivalents, rather than by the examples given.

I claim:

1. A hand held illuminated safety signal comprising:
a handle portion,
a signal portion,
an electrical source,
illumination means,
an on/off switch,
wherein the handle portion comprising a first end connected to the signal portion, a mid-section, and a second end opposite the first end, and a connector disposed at the outermost end of the second end,
wherein the signal portion comprising a front surface and a back surface, said front and back surfaces including aligned screw holes for receiving screws that interconnect the front surface to the back surface, and a printed portion on the front and back surfaces,
wherein the illumination means is disposed within the signal portion, said illumination means having a multiplicity of LEDs arranged on a substantially planar surface.

2. A hand held illuminated safety signal visible from opposite directions of traffic comprising:
a handle portion,
a signal portion attached to the handle portion,
a first substantially planar display of multiple LEDs casting light through a front surface of the signal portion in a first direction,
a second substantially planar display of multiple LEDs casting light through a back surface of the signal portion in a direction opposite to said first direction,
an electrical source,
supporting means for aligning said first planar display of LEDs and said second planar display of LEDs within the signal portion to properly illuminate light in both of said directions.

3. A hand held illuminated safety signal comprising:
a handle portion;
a sign portion attached to the handle portion;
wherein the sign portion comprising a first substantial planar display of multiple LEDs casting light through a front surface of the sign portion in a first direction, and a second substantial planar display of multiple LEDs casting light through a back surface of the signal portion in a direction opposite to said first direction, such that the sign portion is visible from both of said directions of traffic.
